(19) United States
(12) Patent Application Publication
(10) Pub. No.: US 2025/0328396 A1
(43) Pub. Date: Oct. 23, 2025

(54) USER INTERFACE COMPONENT AND WORKFLOW GENERATOR

(71) Applicant: Dell Products L.P., Round Rock, TX (US)

(72) Inventors: Connor David Doria, Raleigh, NC (US); Nikita Joshi, Sammamish, WA (US); Shekhar Ghanasham Joshi, Holly Springs, NC (US); Bryan David Neumann, Garner, NC (US)

(21) Appl. No.: 18/642,570

(22) Filed: Apr. 22, 2024

(51) Int. Cl. G06F 9/54

(52) U.S. Cl. CPC G06F 9/543

(57) ABSTRACT

A method for generating application components includes: obtaining an application programming interface (API) specification from an API library, obtaining configuration information from a client device, generating, using the API specification and the configuration information, a client library in a typescript format, generating, based on a templatized file and using the client library, an application component for an application to be used by the client device, wherein the application component comprises an user interface (UI) component, and providing the application component to the client device.

### BACKGROUND

In a computing environment, application programming interface (API) specifications are commonly used to assist in the development of applications. However, current implementations only generate backend libraries and scaffolding. Currently, there are no methods to generate user interface (UI) components that parallel the API specification. Embodiments disclosed herein may provide developers with UI components to use as a starting point for new applications or to integrate with existing application code.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system including a client system, an application programming interface (API) library, and an API build tool in accordance with one or more embodiments of the invention.

FIG. 1B shows a diagram of a client node in accordance with one or more embodiments of the invention.

FIG. 1C shows a diagram of an application programming interface (API) library in accordance with one or more embodiments of the invention.

FIG. 1D shows a diagram of an API build tool in accordance with one or more embodiments of the invention.

FIG. 2 shows a flowchart of a method for generating one or more UI components in accordance with one or more embodiments of the invention.

FIG. 3 shows a diagram of an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments of the invention relate to system and methods for generating client libraries that include one or more user interface (UI) components or workflows for applications. One or more embodiments improve upon traditional methods of generating client libraries by providing additional front end components to a client. In existing technology, API libraries and building tools are used to generate backend client libraries, but have not yet been used to generate frontend UI components. In the context of this invention, an application programming interface (API) may refer to any software that allows two or more components of a system to communicate with each other. The “backend” of an application, as used in one or more embodiments disclosed herein, refers to the programming of the application and application components that may not directly interact with the user of the application. The “backend” of an application may refer to the API specification, discussed at length below. The “frontend,” as used herein, refers to aspects of the application that may interact directly with the user, such as, for example, UI components. The user may see and interact with a variety of UI components, including but not limited to, a typescript, HyperText Markup Language (HTML) file, cascading style sheets (CSS) files, workflows, buttons, icons, lists, forms, etc. Typescript may be a common programming language used in UI frameworks. One or more embodiments of the invention disclosed herein allow for a client to use an API specification and an API build tool to generate frontend UI components that align with the information included in the API specification.

The following describes various embodiments disclosed herein.

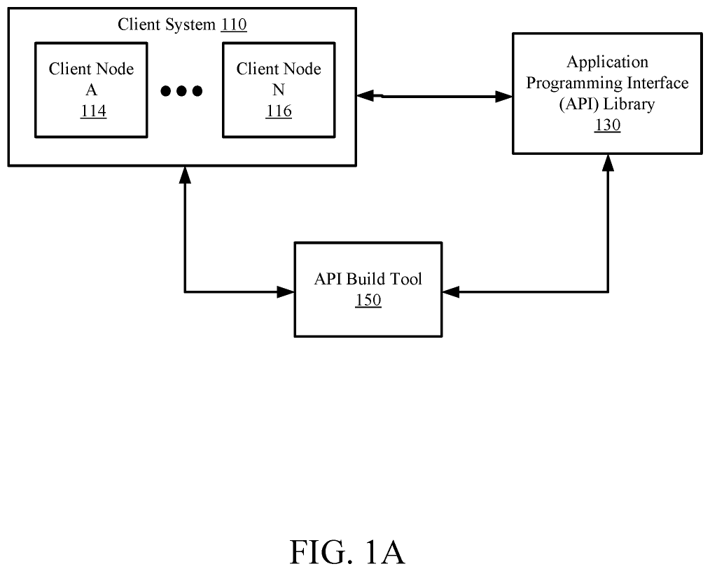

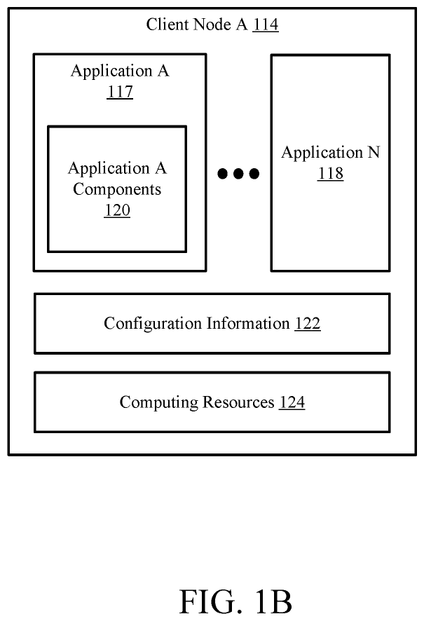

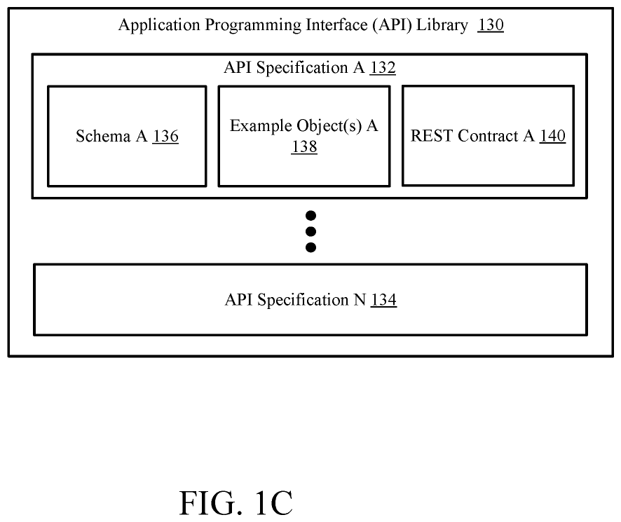

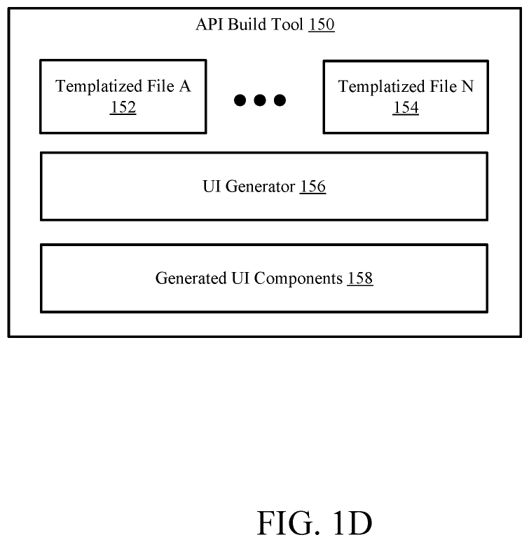

FIG. 1A shows a diagram of a system (100) in accordance with one or more embodiments of the invention. The system may include a client system (110), an application programming interface (API) library (130), and an API build tool (150). Each of the components of the system (100) are operatively connected. The system may include additional, fewer, and/or other components without departing from the invention. Each of the aforementioned components of the system (100) is discussed below.

In one or more embodiments, the client system (110) may host any number of client nodes (114, 116). Each client node (114, 116) may utilize the services of the API build tool (150) to obtain application components (such as UI components) for building an application. The client system (110) may include additional, fewer, and/or other components without departing from the invention. Additional information on the client nodes (114, 116) can be found, for example, in FIG. 1B.

In one or more embodiments, the client nodes (114, 116) are implemented as computing devices. A computing device may be, for example, a tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a client of the client nodes (114, 116) as described throughout this application.

In one or more embodiments, a client of the clients (110A, 110N) is implemented as a logical device. The logical device may utilize the computing resources of any number of computing devices and thereby provide the functionality of the client as described throughout this application.

In one or more embodiments, the API library (130) refers to a catalog of API specifications (132, 134, FIG. 1C) that are available to client systems (110) in order to generate applications (117, 118, FIG. 1B) and/or application components (120, FIG. 1B). The API specifications (132, 134, FIG. 1C) provides information that is implementable by client systems (110) to understand how an API functions, and how the API can be implemented on the client system (110). One example of an API library (130) may be OpenAPI. In one or more embodiments, the API library (130) may be open source. Said another way, the API specifications stored in the API library (130) may be accessible to the public. Additional information on the components of the API library (130) can be found, for example, in FIG. 1C.

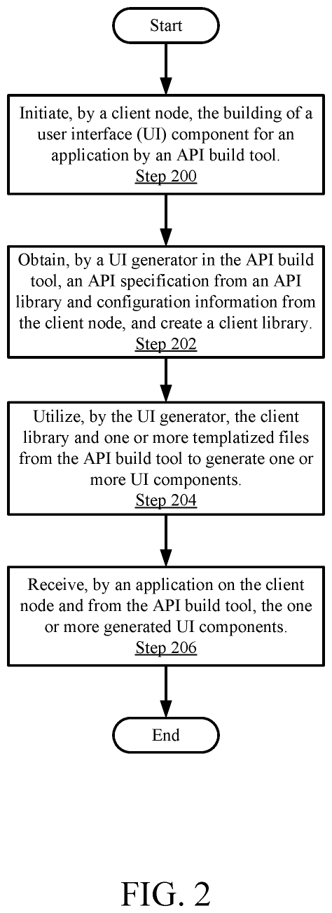

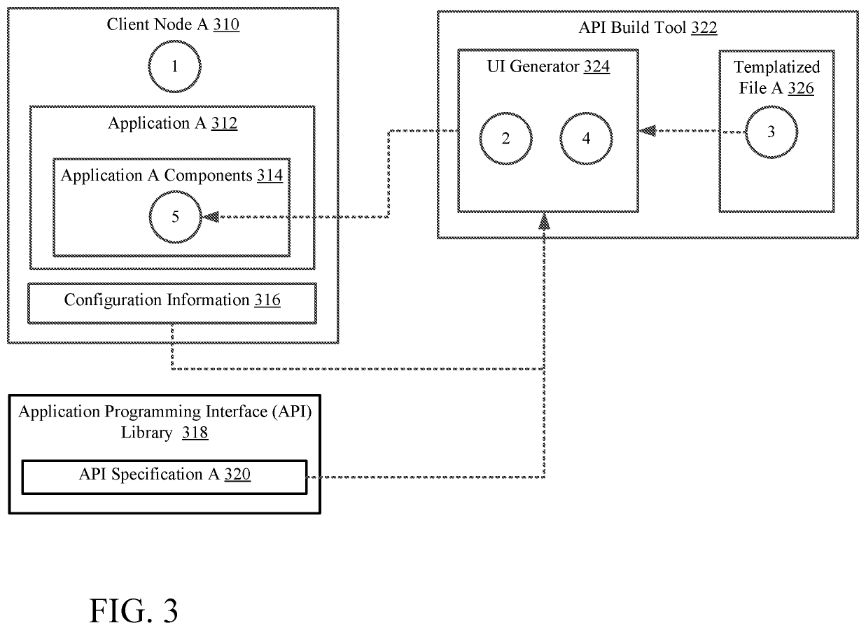

In one or more embodiments, the API build tool (150) may refer to a tool used to generate UI components and workflows based on information including, but not limited to, API specifications (132, 134, FIG. 1C) and configuration information (122, FIG. 1B). One example of an API build tool (150) may be OpenAPI-Generator. Additional information on the components of the API build tool (150) can be found, for example, in FIG. 1D. Information of the implementation of the API build tool (150) in generating UI components and workflows can be found, for example, in FIGS. 2 and 3.

Turning now to FIG. 1B, FIG. 1B shows a diagram of a client node (114) in accordance with one or more embodiments of the invention. The client node (114) of FIG. 1B may be an embodiment of a client node (114, 116, FIG. 1A) discussed above. The client node may include one or more applications (117, 118), configuration information (122), and computing resources (124). The client node (114) may include additional, fewer, and/or different components without departing from the invention. Each of the aforementioned components of the client node (114) is discussed below.

In one or more embodiments, each application (117, 118) may refer to at least one application that may exist on the client node (114) and may perform a variety of functionalities for the client node (114). Functionalities of the applications may include, but not limited to, performing one or more tasks, managing data (e.g., reading data, writing data, collecting data, etc.), etc. Each of the applications (117, 118) may include multiple application components (120), discussed below.

In one or more embodiments, the application components (120) may refer to components that have been created and implemented on the applications (117, 118). Such components may include, for example, UI components. The UI components implemented on an application may include typescript files, HTML files, CSS files, workflows, buttons, icons, lists, tables, forms, etc. Additional information about the creation of UI components that may be included in the application components (120) may be found, for example, in FIGS. 2 and 3.

In one or more embodiments, the configuration information (122) refers to information about the specific hardware and software aspects of the client node (114). The configuration information (122) may include, but is not limited to, information about operating system configuration of the client node, information about the browser used by the client node, and information about hardware of the client node. Additional information on how the configuration information (122) is implemented to generate UI components for applications (117, 118) of a client node (114) may be found, for example, in FIGS. 2 and 3.

In one or more embodiments, the computing resources (124) for the client node (114) may refer to hardware or software elements of the client node (114) that may be available or unavailable to perform tasks. Computing resources (124) may include, but are not limited to, resources such as volatile storage, persistent storage, central processing unit (CPU) usage, graphics processing unit (GPU) usage, power, and networking interfaces. The computing resources (124) available to each client node (114) may be dependent on the amount of tasks on the client node (114) at any given time.

Turning now to FIG. 1C, FIG. 1C shows an API library (130) in accordance with one or more embodiments of the invention. The API library (130) of FIG. 1C may be an embodiment of the API library (130, FIG. 1A) discussed above. The API library (130) may store any number of API specifications (132, 134). Each API specification (132, 134) may include information, used by developers, such as resource types, relationships, and behaviors that the generated API components should adhere to. In one or more embodiments, each API specification (132, 134) may include a schema (136), one or more example objects (138), and a REST contract (140). The API library (130) may include additional, fewer, and/or different components without departing from the invention. Each of the aforementioned components of an API specification (132) in the API library (130) is discussed below.

In one or more embodiments, the schema (136) included in each API specification (132, 134) in the API library (130) includes information on how a set of example objects included in the API specification (132, 134) is related. In one or more embodiments, the example object(s) (138) refer to objects that have certain properties that affect the structure and function of applications, UI components, or workflows using the API specification (132, 134). Objects that are included in each API specification (132, 134) may include, but are not limited to, info objects, contact objects, license objects, server objects, components objects, paths objects, operation objects, etc.

In one or more embodiments, the Representational State Transfer (REST) contract (140) refers to a software architecture that may specify conditions on any components or applications generated using an API specification (132). Conditions in a REST contract (140) may include, but are not limited to, standardized formats of transferring data, requiring statelessness, requiring layers, required cacheability, etc. Conditions included in the REST Contract (140) may affect the one or more generated UI components (158) provided to a client node (114, 116, FIG. 1A). Additional information on the inclusion of REST contracts (140) in the generation of UI components may be found, for example, in FIGS. 2 and 3.

Turning now to FIG. 1D, FIG. 1D shows an API build tool (150) in accordance with one or more embodiments of the invention. The API build tool (150) of FIG. 1D may be an embodiment of the API build tool (150, FIG. 1A) discussed above. The API build tool (150) may include a plurality of templatized files (152, 154), a UI generator (156), and generated UI components (158). The API build tool (150) may include additional, fewer, and/or different components without departing from the invention. Each of the aforementioned components of the API build tool (152) is discussed below.

In one or more embodiments, the templatized files (152, 154) refer to generated templates that can be implemented along with API specifications (132, 134, FIG. 1C) for the purpose of application component generation. Templatized files (152, 154) may be, for example, in typescript format in order to generate specific types of UI components and their parts, including but not limited to, typescript files, HTML, CSS, etc. Templatized files (152, 154) may provide the framework to be used by the API build tool (150) to generate UI components including, but not limited to, buttons, lists, icons, or any other frontend component of an application that is interacted with by a user. Templatized files (152, 154) may include parameters that may be filled in by a client via a client node (114, 116, FIC. 1A) during the process of UI component generation as discussed in FIGS. 2 and 3.

In one or more embodiments, the UI generator (156) generates UI components using information from the configuration information (122, FIG. 1B), an API specification (132, FIG. 1C), and at least one of the templatized files (152, 154). Details on the functionality of the UI generator (156) in the context of this invention can be found, for example, in FIGS. 2 and 3.

In one or more embodiments, the generated UI components (158) may refer to any UI components or workflows generated by the UI generator (156) on the API build tool (150) for any number of client nodes (114, 116, FIG. 1A) on a client system (110, FIG. 1A). The generated UI components (158) are created using information from the configuration information (122, FIG. 1B), an API specification (132, FIG. 1C), and at least one of the templatized files (152, 154). The UI components (158) that exist on the API build tool (150) may also be implemented on any number of applications (117, 118, FIG. 1B) as application components (120, FIG. 1B). Additional information on the generation of generated UI components (158) can be found, for example, in FIGS. 2 and 3.

One of ordinary skill will appreciate that the API build tool (150) may perform other functionalities without departing from the scope of the embodiments disclosed herein. The API build tool (150) may be implemented using hardware, software, or any combination thereof.

Turning now to FIG. 2, FIG. 2 shows a flowchart of a method generating one or more UI components in accordance with one or more embodiments of the invention. The method may be performed by, for example, the UI generator (e.g., 156, FIG. 1D). Other components of the system illustrated in FIGS. 1A-1D may perform all, or a portion, of the method of FIG. 2 without departing from the scope of the invention.

While FIG. 2 is illustrated as a series of steps, any of the steps may be omitted, performed in a different order, include additional steps, and/or perform any or all of the steps in a parallel and/or partially overlapping manner without departing from the scope of the invention.

In Step 200, a client node initiates the building of a UI component(s) for an application by the API build tool.

In Step 202, a client library is created using an API specification and configuration information for the client node that is obtained by the UI generator in the API build tool. The API specification is obtained from an API library. The API specification is selected based on the type of UI component(s) or workflow requested by, for example, a client node initiating the building of the UI components. The client library may be in a typescript format, and may be generated by the API build tool based on the API specification. The client library may be generated based on any aspects of the API specification, including but not limited to, the schema, objects, or REST contract.

In Step 204, one or more templatized files from the API build tool are utilized by the UI generator to generate one or more UI components. The templatized file(s) includes the framework needed to generate the desired UI component(s) and their relevant parts for the application on the client node that initiated the building of the UI component(s). The typescript client library generated using an API specification and the configuration information in Step 202 is combined with the templatized file(s) to generate the one or more UI components and their parts. These parts include things such as HTML, CSS, test and typescript files to create a complete UI component. The user may fill in parameters in the templatized file during the generation process of the UI component(s).

In Step 206, the one or more generated UI components are received by an application on the client node from the API build tool after the API build tool provides the generated UI components to the client node.

In one or more embodiments, the method may end following Step 206.

### Example

The following section describes an example. The example, illustrated in FIG. 3, is not intended to limit the invention. Turning to the example, consider a scenario in which a system includes a client node that requests a restoration of a specific version of a data asset.

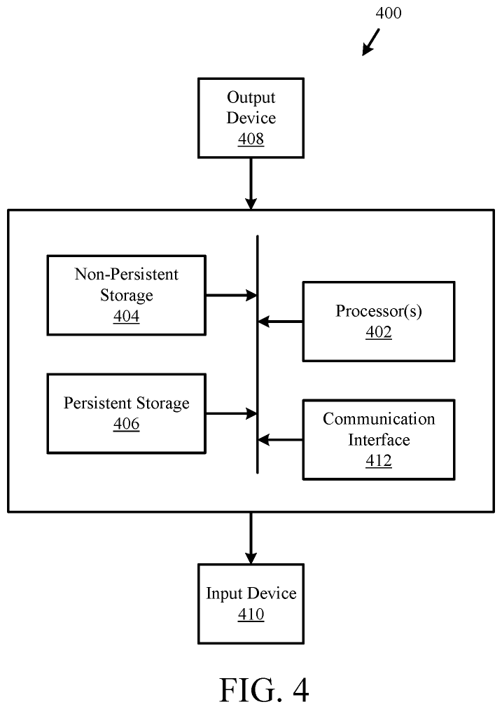

Turning to FIG. 3, FIG. 3 shows a diagram of an example system. For the sake of brevity, not all components of the example system are illustrated in FIG. 4. The example system includes at least a client node A (310), an API library (318), and an API build tool (322). The client node (310) includes an application (312) and configuration information (316). The application (312) may include any number of application components (314). The API library (318) includes at least one API specification (320). The API build tool (322) includes a UI generator (324) and at least one templatized file (326). Other components in the system depicted in FIGS. 1A-1D may perform all, or a portion of the steps shown in FIG. 3 without departing from the scope of the invention.

In the following example, a sequence of operations illustrated in FIG. 3 as the circled numbers are described below using brackets.

In this methodology, a client node A (310) initiates the building of a UI component for an application A (312) that resides on the node [1]. The UI generator (324) on an API build tool (322) obtains configuration information (316) from client node A (310) as well as an API specification A (320) from an API library (318) [2]. In this example, API specification A (320) may be obtained from an API library (318) such as OpenAPI. Using the obtained information, the UI generator (324) creates a typescript client library. In this example, the typescript client library may be created using an API build tool (322) such as OpenAPI-Generator. The UI generator (324) then obtains the templatized file that includes the template needed to generate the desired UI component for application A (312) [3]. In the next step of this example, the typescript client library generated using API specification A (320) and the configuration information (316) is combined with templatized file A (326) to generate one or more UI components and their parts [4]. These parts include things such as HTML, CSS, test and typescript files to create a complete UI component. The generation of the UI components and parts is done by the UI generator (324). A user may fill in parameters included in the templatized files while generating the UI components. Once generated, the UI components are received by application A (312) [5]. The UI components generated based on API specification A (320) and using templatized file A (326) are represented in the example figure as application A components (314). The application A components (314) can now be utilized by and implemented on application A (312) of client node A (310).

An example of a final UI component, generated based on an API specification and templatized files, is included in typescript format below:

```
import { Component, OnChanges, OnInit, SimpleChanges } from
′@angular/core′;
import { MatDialog } from ′@angular/material/dialog′;
import { TestDialogComponent } from ′../test-dialog/test-
dialog.component′;
import { <%= name %>Api } from ′../../../../powerstore-client-
typescript/apis/<%= name %>Api′;
export interface PeriodicElement {
  name: string;
  position: number;
    weight: number;
    symbol: string;
}
export interface DialogData {
    object: any;
}
@Component({
    selector: ′app-<%= lname %>-list-component′,
    templateUrl: ′./<%= lname %>-list-component.component.html′,
    styleUrls: [′./<%= lname %>-list-component.component.scss′]
})
export class TestListComponentComponent implements OnInit,
OnChanges {
    objectName: string = ″<%= lname %>″;
    label2: string = ″″;
    label1: string = ″″;
    listObject: any[ ] = [ ];
    columns: string[ ] = [ ];
    serviceName = this.getService(this.objectName);
    constructor(public dialog: MatDialog,
      private service: <%= name %>Api) { }
    public async ngOnInit( ): Promise<void> {
      this.serviceName = this.getService(this.objectName);
      if (this.serviceName) {
        this.listObject = await this.callServiceMethod(this.serviceName,
this.getApiMethodName(this.objectName));
        this.initializeColumns( );
      }
    }
    public ngOnChanges(changes: SimpleChanges): void {
    }
private initializeColumns( ) {
      if (this.listObject.length > 0) {
        const firstObject = this.listObject[0];
        this.columns = Object.keys(firstObject);
      }
    }
    private getService(objectName: string) {
      switch (objectName) {
        case ′<%= lname %>′:
          return this.service;
        // Add more cases as needed
        default:
          return null;
      }
    }
    private getApiMethodName(objectName: string) {
      return ‘${objectName}Get‘;
    }
    private async callServiceMethod(service: any, methodName:
string): Promise<any[ ]> {
      if (typeof service[methodName] === ′function′) {
        return await service[methodName]( );
      } else {
        // Case where the method does not exist on the service
        return [ ];
      }
    }
openCreate( ): void {
      const dialogRef = this.dialog.open(TestDialogComponent, {
        data: { name: this.listObject[0].name, description:
this.listObject[0].description },
      });
      dialogRef.afterClosed( ).subscribe(result => {
        console.log(′The dialog was closed′);
        this.label1 = result;
      });
    }
    openUpdate( ): void {
      const dialogRef = this.dialog.open(TestDialogComponent, {
        data: { name: this.listObject[0] },
      });
      dialogRef.afterClosed( ).subscribe(result => {
        console.log(′The dialog was closed′);
        this.label1 = result;
      });
    }
}
```

### End of Example

As discussed above, embodiments of the invention may be implemented using computing devices. Turning now to FIG. 4, FIG. 4 shows a diagram of a computing device in accordance with one or more embodiments of the invention. The computer (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) (402) may be one or more cores or micro-cores of a processor. The computer (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computer (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many diverse types of computing devices exist, and the aforementioned input and output device(s) may take other forms.

One or more embodiments of the invention may be implemented using instructions executed by one or more processors of the system including a client system, an application programming interface library, and an application programming interface build tool. Further, such instructions may correspond to computer readable instructions that are stored on one or more non-transitory computer readable mediums.

One or more embodiments of the invention may improve upon the previous method of generating applications and application components. Specifically, embodiments of the invention relate to a system and method for generating UI components for applications on a client node. One or more embodiments improve upon the traditional method of generating client libraries for application creation by additionally using templatized files to generate UI components and workflows. This system includes an API build tool with a UI generator that utilizes API specifications from an API library to assist in the generation of UI components. The UI components generated by the UI generator parallel the REST contract defined in the API specification, and consider the schema and object included in the API specification as well. These additionally generated UI components can be used by users or developers as a starting point for new applications on the client system, or may be integrated with existing applications on client nodes.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for generating application components, the method comprising:
obtaining an application programming interface (API) specification from an API library;
obtaining configuration information from a client device;
generating, using the API specification and the configuration information, a client library in a typescript format;
generating, based on a templatized file and using the client library, an application component for an application to be used by the client device, wherein the application component comprises an user interface (UI) component; and
providing the application component to the client device.

2. The method of claim 1, wherein the configuration information comprises at least one of: information about operating system configuration of the client device, information about browser used by the client device, and information about hardware of the client device.

3. The method of claim 1, wherein the generating of the application component is initiated by the client device.

4. The method of claim 1, wherein the application component further comprises at least one of: a typescript file, a HyperText Markup Language (HTML) file, and a Cascading Style Sheets (CSS) file.

5. The method of claim 1, wherein the templatized file comprises information about the API specification organized based on a template, wherein the template is in the typescript format.

6. The method of claim 1, wherein the application component is stored in the API library as a second API specification.

7. The method of claim 1, wherein the API specification comprises a set of objects, a schema for relating each of the set of objects, and a representational state contract.

8. A non-transitory computer readable medium comprising computer readable program code, which when executed by a computer processor enables the computer processor to perform a method for generating application components, the method comprising:
obtaining an application programming interface (API) specification from an API library;
obtaining configuration information from a client device;
generating, using the API specification and the configuration information, a client library in a typescript format;
generating, based on a templatized file and using the client library, an application component for an application to be used by the client device, wherein the application component comprises an user interface (UI) component; and
providing the application component to the client device.

9. The non-transitory computer readable medium of claim 8, wherein the configuration information comprises at least one of: information about operating system configuration of the client device, information about browser used by the client device, and information about hardware of the client device.

10. The non-transitory computer readable medium of claim 8, wherein the generating of the application component is initiated by the client device.

11. The non-transitory computer readable medium of claim 8, wherein the application component further comprises at least one of: a typescript file, a HyperText Markup Language (HTML) file, and a Cascading Style Sheets (CSS) file.

12. The non-transitory computer readable medium of claim 8, wherein the templatized file comprises information about the API specification organized based on a template, wherein the template is in the typescript format.

13. The non-transitory computer readable medium of claim 8, wherein the application component is stored in the API library as a second API specification.

14. The non-transitory computer readable medium of claim 8, wherein the API specification comprises a set of objects, a schema for relating each of the set of objects, and a representational state contract.

15. A system, comprising:
a processor; and
memory including instructions, which when executed by the processor, perform a method comprising:
obtaining an application programming interface (API) specification from an API library;
obtaining configuration information from a client device;
generating, using the API specification and the configuration information, a client library in a typescript format;
generating, based on a templatized file and using the client library, an application component for an application to be used by the client device,
wherein the application component comprises an user interface (UI) component, and
wherein the templatized file comprises information about the API specification organized based on a template, wherein the template is in a typescript format; and
providing the application component to the client device.

16. The system of claim 15, wherein the configuration information comprises at least one of: information about operating system configuration of the client device, information about browser used by the client device, and information about hardware of the client device.

17. The system of claim 15, wherein the generating of the application component is initiated by the client device.

18. The system of claim 15, wherein the application component further comprises at least one of: a typescript file, a HyperText Markup Language (HTML) file, and a Cascading Style Sheets (CSS) file.

19. The system of claim 15, wherein the application component is stored in the API library as a second API specification.

20. The system of claim 15, wherein the API specification comprises a set of objects, a schema for relating each of the set of objects, and a representational state contract.
